(19) United States
(12) Patent Application Publication
(10) Pub. No.: US 2014/0096395 A1
(43) Pub. Date: Apr. 10, 2014

(54) SANITARY STRAIGHT RAZOR APPARATUS AND SYSTEM

(71) Applicant: John W. GRINER, Niskayuna, NY (US)

(72) Inventor: John W. GRINER, Niskayuna, NY (US)

(21) Appl. No.: 13/646,851

(22) Filed: Oct. 8, 2012

(51) Int. Cl. B26B 21/00; B26B 21/44; B26B 21/10

(52) U.S. Cl. 30/40; 30/526; 30/47; 30/41

(57) ABSTRACT

A sanitary straight razor is provided having a universal handle unit and a disposable head unit. The entirety of the head unit is disposable so that for each shave, a new and sanitary blade is provided. The head unit can be attached and detached without the need for the head unit itself to be handled by a user. Health and sanitation risks are advantageously alleviated, offering benefits to service providers, such as professional barbers and cosmetologists, who deal with hundreds of individuals, where sanitation and safety is of paramount importance. Additionally, the sanitary straight razor can be provided along with a razor blade assembly rack as part of a sanitary straight razor system, which razor blade assembly rack holds multiple disposable razor blade assemblies and facilitates easy, sanitary replacement of the disposable razor blade assembly.

### BACKGROUND

Straight razors are typically used for hair removal from areas including an individual's face, neck, eyebrows, and hairlines. Though less common than safety razors, in particular multi-blade, disposable cartridge-style razors, straight razors are used by both individuals for their personal shaving needs and service providers, such as professional barbers and cosmetologists, in providing a premium shave experience for their customers. However, because of the dangers associated with existing straight razors, some would-be users have shied away from using them. The exposed blade, for instance, necessitates utmost care in handling and maintaining in a safe manner. Additionally, the nature of a straight razor is such that blood and other biological material are introduced to the blade and other areas of the razor, posing potential health risks when the razor and/or blade is used for hair removal on multiple subjects. What is needed is a sanitary straight razor apparatus that helps mitigate these dangers.

### BRIEF SUMMARY

The shortcomings of the prior art are overcome and additional advantages are provided through the provision of a sanitary straight razor apparatus. The sanitary straight razor apparatus includes, for instance: an elongate body including a first body end and a second body end; an elongate handle including: an ergonomic shape for gripping, a first handle end, and a second handle end, wherein the first handle end of the elongate handle is connected to the second body end of the elongate body, and wherein the second handle end of the elongate handle includes a receiving port; and a disposable razor blade assembly including: a head fixedly assembled with a blade, a first assembly end configured to connectably engage with the receiving port, and a second assembly end.

Further, a sanitary straight razor apparatus is provided that includes, for instance: an elongate handle including: an ergonomic shape for gripping, a first handle end, and a second handle end, wherein the second handle end includes a receiving port; and a disposable razor blade assembly including: a head fixedly assembled with a blade, a first assembly end that configured to connectably engage with the receiving port, and a second assembly end, wherein the elongate handle and the disposable razor blade assembly are connectably engaged to form a singular structure so that said first assembly end and said second handle end are integrally joined.

Yet further, a sanitary straight razor system is provided which includes, for instance: an elongate body including a first body end and a second body end; an elongate handle including: an ergonomic shape for gripping, a first handle end, and a second handle end, wherein the first handle end is connected to the second body end of the elongate body, and wherein the second handle end includes a receiving port; a disposable razor blade assembly including: a head fixedly assembled with a razor, a first assembly end configured to connectably engage with the receiving port, and a second assembly end; and a razor blade assembly rack configured to hold the disposable razor blade assembly and at least one other disposable razor blade assembly in a substantially parallel fashion, wherein when the disposable razor blade assembly is held in the razor blade assembly rack, the first assembly end is accessible to engage with the receiving port of the second handle end of the elongate handle to facilitate extraction of the disposable razor blade assembly from the razor blade assembly rack.

Additional features and advantages are realized through the concepts of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1-3 depict one embodiment of a sanitary straight razor apparatus, in accordance with one or more aspects of the present invention;

FIG. 4 depicts one example of a razor blade assembly rack for holding disposable razor blade assemblies in accordance with one or more aspects of the present invention; and

FIG. 5 depicts another embodiment of a sanitary straight razor apparatus, in accordance with one or more aspects of the present invention.

### DETAILED DESCRIPTION

Current straight razors typically employ a permanent blade that is used for the entire life of the straight razor. The blade is maintained (e.g. cleaned, sharpened) by the user but comes into contact each individual that receives a shave using that straight razor. Quite obviously, razor blades are very sharp and can cause cuts, some of which are much smaller and less apparent than others, an so biological material, even if not visible, can remain on the blade and/or head portion of the razor. Additionally, skin cells, hair follicles, etc. can remain on the blade and other parts of the razor and be communicated between individuals, posing health concerns if proper precautions and/or sterilization procedures are not obeyed.

Though some straight razors employ disposable blades that load into the razor's handle, similar concerns as those noted above nevertheless exist with these options. For instance, the disposable blades are still handled (touched) by the operator of the razor in order to extract and replace old blades with new ones. Consequently, the user (e.g. barber) comes into contact with potentially harmful biological and other material (blood, cells, saliva, dirt, etc) as a result of touching the used blades. Because of this, sanitation and sterilization precautions are still necessary to avoid transmission of pathogens (including diseases such as hepatitis, and human immunodeficiency virus/acquired immunodeficiency syndrome (HIV/AIDS)). Constant spraying of the razor and blades with disinfectant is common, which can be tedious, hazardous, and ineffective if not performed properly.

Additionally, not only is the blade of a straight razor an area of concern in terms of pathogens, but other parts of the razor are as well. For instance, the handle and/or head area similarly comes into contact with each individual receiving a shave from the straight razor (as well as the barber or other user of the unit) and therefore can harbor and carry potentially dangerous biological and other material between users.

Aspects of the present invention advantageously address the above sanitation and health concerns associated with existing straight razors. Embodiments of a straight razor according to aspects of the present invention include a universal handle unit and disposable head unit(s) that can carry one or more blades of varying sizes and shapes, selected depending on their particular application (face shave, neck shave, edging eyebrows and hairlines, etc.) and/or on the features of the particular recipient receiving the shave (skin type, profile, etc.). Devices according to aspects of the present invention offer benefits from a sanitation standpoint and can be used by professional barbers and cosmetologists, for instance, who deal with hundreds of individuals, where sanitation and safety is of paramount importance. Additionally, the safety benefits are useful not only for professional service providers but also for consumer/personal users.

In accordance with an embodiment of the present invention, a sanitary straight razor includes a head unit, the entirety of which is disposable so that each blade, which is housed partially within the disposable head unit, will be clean (i.e. never have come into contact with any user) and new for each individual. The head unit can be attached and detached without the need for the head unit itself to be handled by the user (e.g. absent manual hand manipulation of the head unit), which lessens the possibility of contamination.

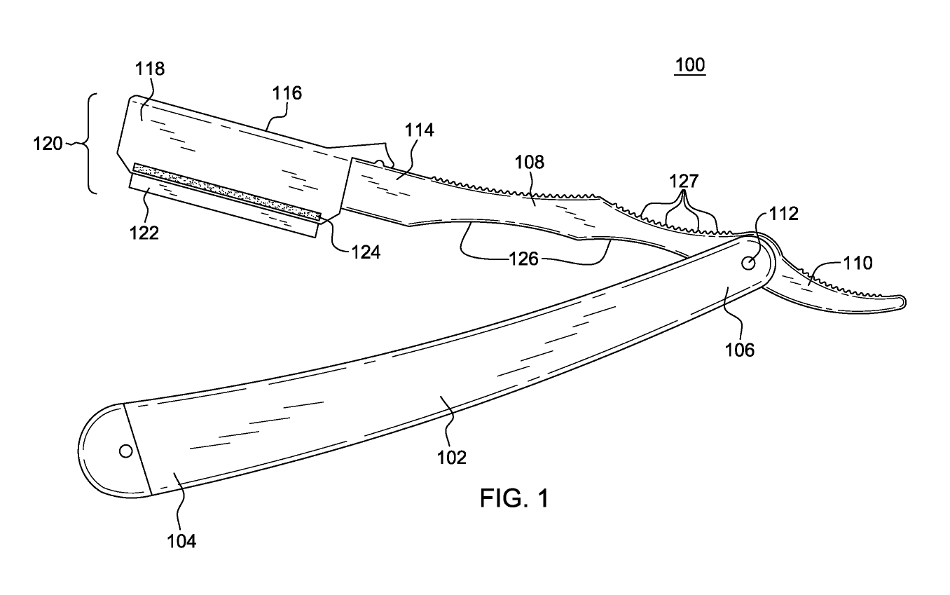

Turning to the illustrations, FIGS. 1-3 depict one embodiment of a sanitary straight razor apparatus, in accordance with one or more aspects of the present invention. Depicted in FIG. 1 is a side-view of a sanitary straight razor apparatus 100 in accordance with this embodiment. In FIG. 1, sanitary straight razor 100 includes an elongate body 102 having a first body end 104 and a second body end 106. Pivotably connected to elongate body 102 at second body end 106 thereof is an elongate handle 108. More specifically, first handle end 110 of elongate handle 108 is pivotably connected to second body end 106 by way of a rivet 112 such that elongate handle 108 can swing open/closed with respect to elongate body 102.

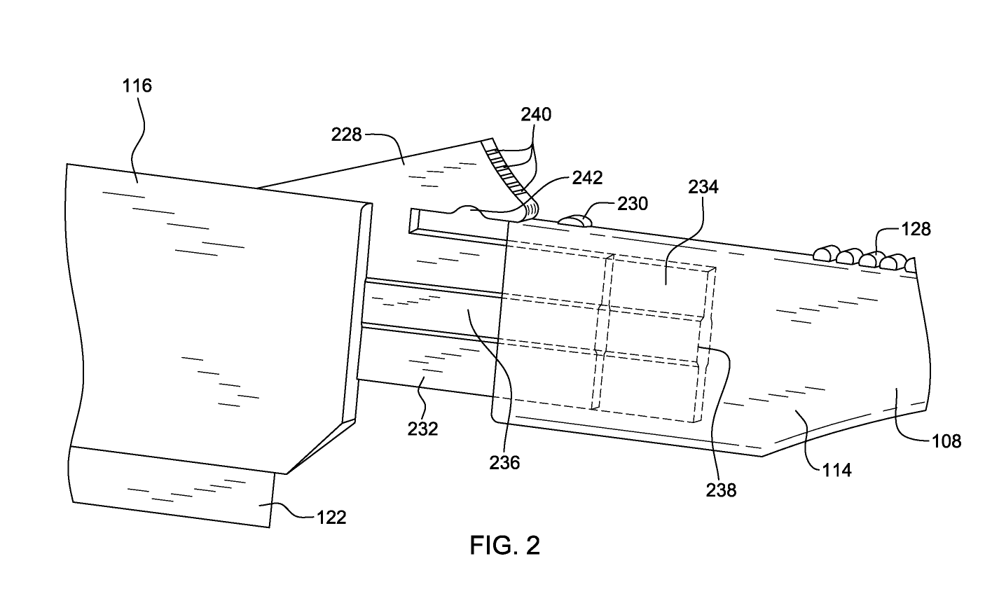

Elongate handle 108 also includes second handle end 114 that includes a receiving port 234 (see FIG. 2) for connectably engaging with a first assembly end 232 (FIG. 2) of disposable razor blade assembly 116. Disposable razor blade assembly 116 includes first assembly end 232 and opposing second assembly end 118. Disposable razor blade assembly 116 also includes head 120 fixedly assembled with a razor blade 122. In this example, head 120 is molded plastic having razor blade 122 embedded partially therein such that razor blade 122 protrudes from head 120 in order to (partially) expose blade 122. In one example, the protruding blade is irremovably positioned in the head. In other examples, blade 122 is not embedded within head 120, but is coupled or otherwise fixedly (permanently, or removably) attached to head 120.

Additionally, moisturizing strip(s) can be provided on head 120 just above where blade 122 protrudes from head 120. Moisturizing strip(s) is/are optionally provided to aid in soothing/preventing of skin irritation that may occur as a result of razor 122 sweeping across the skin surface. In FIG. 1's side view of straight razor 100, moisturizing strip 124 is depicted.

Elongate handle 108 is formed having an ergonomic shape with grooves 126 for proper finger placement on razor 100, and ease and comfort of operation thereof. Additionally, non-slip grips 127 are provided on elongate handle 108, which grips facilitate safe handling of straight razor 100 during operation thereof. Though not depicted in FIG. 1, non-slip grips may also be provided along grooves 126, if desired.

As noted, disposable razor blade assembly 116 connectably engages with elongate handle 108. This aspect is further illustrated and described with reference to FIG. 2, which depicts a partial side view of sanitary straight razor apparatus 100 of FIG. 1. In FIG. 2, disposable razor blade assembly 116 is shown partially disengaged (decoupled) from elongate handle 108 (i.e. at second handle end 114). Disposable razor blade assembly 116 is provided with a head lock 228 which engages with a projection 230 on a top edge of elongate handle 208. More particularly, when first assembly end 232 of disposable razor blade assembly 116 slides into receiving port 234 of second handle end 114, projection 230 engages with receptacle 242 of head lock 228 forming an interference fit in which disposable razor blade assembly 116 is held in a fixed position with respect to elongate handle 108. Additionally, a tongue 236 (of first assembly end 232) and groove 238 (of second handle end 114) arrangement is provided to further facilitate holding disposable razor blade assembly 116 in fixed position with respect to elongate handle 108. Disposable razor blade assembly 116 is thereby secured to elongate handle 108 by way of the slide-in lock mechanism, in order to facilitate safe performance of the shave.

When disposable razor blade assembly 116 is to be disposed-of, it is decoupled from elongate handle 108 and the rest the razor using manual hand manipulation. The manipulation is such that the user can eject disposable razor blade assembly 116 with one hand, for instance by holding elongate handle 108 in his/her palm and pressing outwardly on head lock 228, which is provided with grooves 240 for traction, using his/her thumb to separate disposable razor blade assembly 116 from elongate handle 108. Such a single-handed, touch-button release eliminates the need for the user to touch a used blade, head, or other portion of the razor that has come into contact with the individual.

Other lock mechanisms for properly holding disposable razor blade assembly 116 in place are possible, and other arrangements for connectably engaging and disengaging elongate handle 108 from disposable razor blade assembly 116 will be readily apparent to those having ordinary skill in the art.

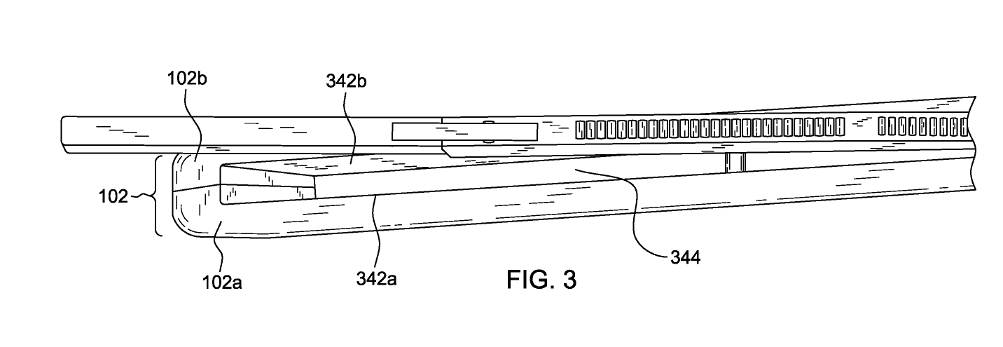

FIG. 3 depicts a partial top view of sanitary straight razor apparatus 100. Elongate body 102 includes two planar members 102a and 102b. Member 102a includes substantially planar inner surface 342a, and member 102b includes substantially planar inner surface 342b. Members 102a, 102b are formed so that when they are press-fit together, planar surfaces 342a and 342b are spaced apart by an elongate groove 344 into which some or all of elongate handle 108 and/or disposable razor blade assembly 116 collapses. In this example, sanitary straight razor 100 is partially collapsed/closed. When fully closed, at least some (and in some embodiments, all) of elongate handle 108 and/or disposable razor blade assembly 116 is collapsed into elongate body 102, and more specifically, into elongate groove 344 thereof. For instance, elongate handle 108 swings with respect to elongate body 102 so that razor blade 122 is concealed within elongate groove 344. This is useful in situations where disposable razor blade assembly 116 is still being used, and therefore remained connected to elongate handle 108, but the razor is to be temporarily collapsed for safety purposes, as an example.

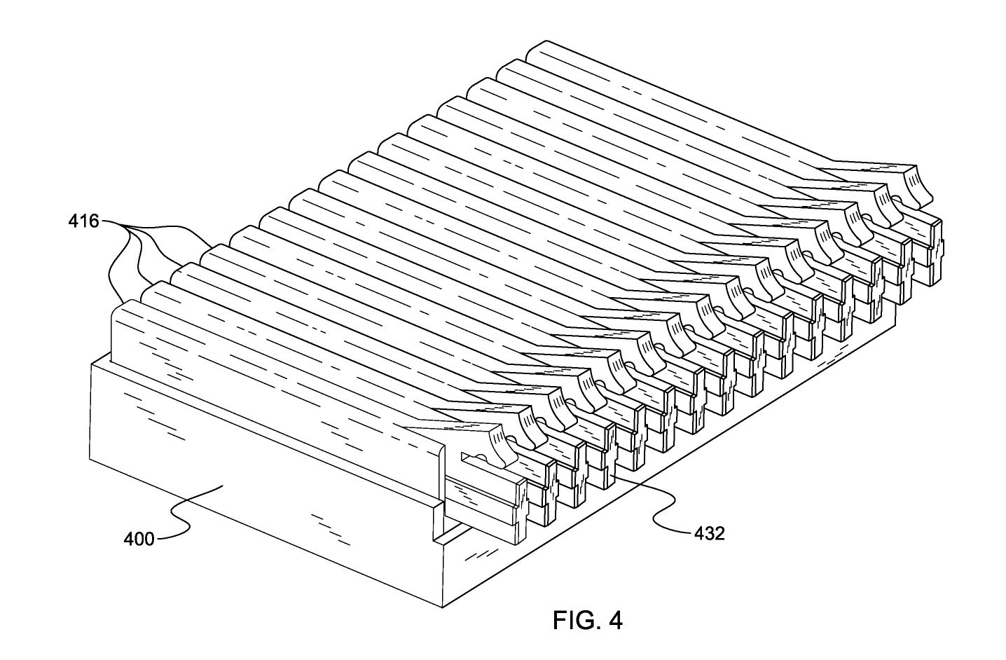

FIG. 4 depicts one example of a razor blade assembly rack for holding disposable razor blade assemblies in accordance with one or more aspects of the present invention. Razor blade assembly rack 400 is configured to hold a plurality of disposable razor blade assemblies 416 for easy access to the assemblies, which are maintained in substantially parallel fashion within razor blade assembly rack 400. In particular, the first assembly end 432 of each assembly 416 is accessible to enable ready engagement of the assembly with the elongate handle of a sanitary straight razor apparatus as described above and in accordance with aspects of the present invention. For instance, a user can grip razor blade assembly rack 400 and press a second handle end of the elongate handle onto/around an exposed first assembly end 432 of an assembly 416. The first assembly end will enter the receiving port on the handle, and the force of the handle pushing toward the assembly 416 engages the head lock thereof to secure the assembly to the handle and rest of the razor. The assembly 416, now attached to the razor, can be lifted out of the razor blade assembly rack. Advantageously, a disposable razor blade assembly can be attached to the elongate handle absent any direct handling of the actual disposable razor blade assembly by the user. Thus, both the attachment and detachment of the assembly to the razor are achieved without any touching of any part of the head or blade of the disposable razor blade by the user.

The above configuration also enables a variety of different disposable razor blade assemblies to be used with a single elongate handle, so long as the assembly is provided with an end that is compatible with the elongate handle. Razor blade assemblies in accordance with aspects of the present invention can be made to have differing number, thickness, type, size, sharpness, etc. of blades, for instance. Additionally or alternatively, different head sizes can be provided, which is advantageous depending on the particular application (i.e. eye brow edging, hair line edging, neck shaving, face shaving, etc.) and/or particular individual being shaved. Thus, different disposable assemblies can be provided that better accommodate particular jobs. In this manner, virtually any type of blade/head unit configuration can be employed, so long as it is configured to properly engage with the universal elongate handle provided in accordance with aspects of the present invention.

The sanitary straight razor apparatus can include different blade assembly types that are compatible with a universal elongate handle/elongate body combination. In one example, the elongate handle/elongate body combination can be provided (e.g. sold) separate from one or more disposable razor blade assemblies. In one example, multiple different disposable razor blade assemblies can be provided (e.g. sold) as part of a single razor blade assembly rack. For instance, a razor blade assembly rack containing multiple different disposable razor blade assemblies (e.g. different blades or different sizes) can be provided as a ‘kit’, wherein one or more disposable razor blade assemblies is provided for each of several different shaving applications (i.e. one or more assemblies for face shaving, one or more for edging, etc.).

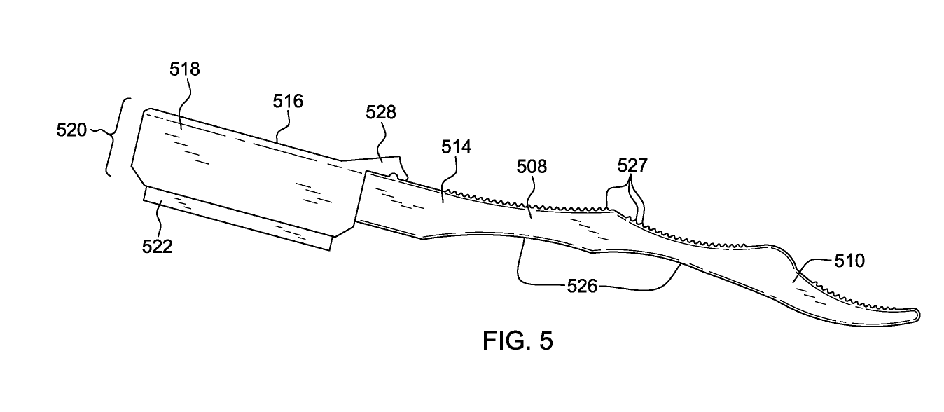

FIG. 5 depicts another embodiment of a sanitary straight razor apparatus, in accordance with one or more aspects of the present invention. The sanitary straight razor apparatus of FIG. 5 is similar to sanitary straight razor apparatus 100 of FIG. 1, with the primary difference being that elongate body 102 is removed. Thus, the sanitary straight razor apparatus of FIG. 5 includes an elongate handle 508 having first handle end 510 and second handle end 514. Elongate handle 508 is provided with non-slip grips 527 and grooves 526 for proper finger placement, as before. Additionally, disposable razor blade assembly 516 is provided, having a head 520 and blade 522 protruding therefrom, and also including first assembly end (not pictured) engaging with second handle end 514, and second assembly end 518. Head lock 528 engages as described above to couple and hold disposable razor blade assembly 516 in fixed position with respect to elongate handle 508.

A sanitary straight razor apparatus in accordance with aspects of the present invention can be fabricated having some characteristics similar to those of current straight razors currently offered on the market. For instance, the razor can be constructed with the approximate overall size and weight of existing razors. In accordance with aspects of the present invention, the sanitary straight razor apparatus includes a universal handle which holds blades/heads of varying sizes, shapes, and other features, which can vary depending on the shave needed. Some blades/assemblies can be made to better accommodate certain jobs/shaving purposes, and can be marketed accordingly.

Advantageously, a sanitary straight razor apparatus according to aspects of the present invention is more sanitary than existing offerings for both a customer (receiving the shave) and for a service provider, such as a barber. For instance, a sanitary straight razor apparatus according to aspects of the present invention will accommodate completely touch free loading of the disposable razor blade assembly from the assembly rack, performance of the shave, and disposal of the disposable razor blade assembly to the trash. Thus, the customer receives a shave using a blade and head unit that is unused, sanitary, and untouched by the service provider, and the service provider can dispose of the used (now unsanitary) blade and head unit without touching any portion thereof that can come into contact with the customer.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiment with various modifications as are suited to the particular use contemplated.

What is claimed is:

1. A sanitary straight razor apparatus, comprising:
an elongate body comprising a first body end and a second body end;
an elongate handle comprising: an ergonomic shape for gripping, a first handle end, and a second handle end, wherein the first handle end of the elongate handle is connected to the second body end of the elongate body, and wherein the second handle end of the elongate handle comprises a receiving port; and
a disposable razor blade assembly comprising: a head fixedly assembled with a blade, a first assembly end configured to connectably engage with the receiving port, and a second assembly end.

2. The sanitary straight razor apparatus of claim 1, wherein the disposable razor blade assembly is interchangeable with at least one other disposable razor blade assembly configured to connectably engage with the receiving port.

3. The sanitary straight razor apparatus of claim 2, wherein the head comprises a first head size and the blade fixedly assembled with the head comprises a first blade size, wherein the at least one other disposable razor blade assembly comprises a head fixedly assembled with a blade, and wherein:
the head of the at least one other disposable razor blade assembly comprises a second head size different from the first head size; or
the blade fixedly assembled with the head of the at least one other disposable razor blade assembly comprises a second blade size different from the first blade size.

4. The sanitary straight razor apparatus of claim 1, wherein one of the disposable razor blade assembly or the second handle end further comprises a head lock configured to engage with a receptacle formed upon the other of the disposable razor blade assembly or the second handle end.

5. The sanitary straight razor apparatus of claim 1, wherein the blade is a protruding blade at least partially embedded within the head.

6. The sanitary straight razor apparatus of claim 5, wherein the protruding blade is irremovably positioned in the head.

7. The sanitary straight razor apparatus of claim 1, wherein the first assembly end engages with the receiving port to couple the disposable razor blade assembly to the elongate handle, and wherein the disposable razor blade assembly is configured to de-couple from the elongate handle by manual hand manipulation.

8. The sanitary straight razor apparatus of claim 1, wherein the elongate body is substantially flat and comprises two opposed substantially planar surfaces.

9. The sanitary straight razor apparatus of claim 8, wherein the two opposed substantially planar surfaces are at least partially spaced apart by an elongate groove, and wherein the elongate handle pivots at the first handle end to collapse the disposable razor blade assembly at least partially into the elongate groove.

10. The sanitary straight razor apparatus of claim 1, wherein the disposable razor blade assembly further comprises a moisturizer strip.

11. The sanitary straight razor apparatus of claim 1, wherein the first handle end of the elongate handle is pivotably connected to the second body end of the elongate body.

12. A sanitary straight razor apparatus, comprising
an elongate handle comprising: an ergonomic shape for gripping, a first handle end, and a second handle end, wherein the second handle end comprises a receiving port; and
a disposable razor blade assembly comprising: a head fixedly assembled with a blade, a first assembly end that configured to connectably engage with the receiving port, and a second assembly end, wherein the elongate handle and the disposable razor blade assembly are connectably engaged to form a singular structure so that said first assembly end and said second handle end are integrally joined.

13. The sanitary straight razor apparatus of claim 12, wherein the disposable razor blade assembly is interchangeable with at least one other disposable razor blade assembly configured to connectably engage with the receiving port.

14. The sanitary straight razor apparatus of claim 12, wherein the head comprises a first head size and the blade fixedly assembled with the head comprises a first blade size, wherein the at least one other disposable razor blade assembly comprises a head fixedly assembled with a blade, and wherein:
the head of the at least one other disposable razor blade assembly comprises a second head size different from the first head size; or
the blade fixedly assembled with the head of the at least one other disposable razor blade assembly comprises a second blade size different from the first blade size.

15. The sanitary straight razor apparatus of claim 12, wherein one of the disposable razor blade assembly or the second handle end further comprises a head lock configured to engage with a receptacle formed upon the other of the disposable razor blade assembly or the second handle end.

16. The sanitary straight razor apparatus of claim 12, wherein the blade is a protruding blade at least partially embedded within the head.

17. The sanitary straight razor apparatus of claim 16, wherein the protruding blade is irremovably positioned in the head.

18. The sanitary straight razor apparatus of claim 12, wherein the first assembly end engages with the receiving port to couple the disposable razor blade assembly to the elongate handle, and wherein the disposable razor blade assembly is configured to de-couple from the elongate handle by manual hand manipulation.

19. The sanitary straight razor apparatus of claim 12, wherein the disposable razor blade assembly further comprises a moisturizer strip.

20. A sanitary straight razor system, comprising:
an elongate body comprising a first body end and a second body end;
an elongate handle comprising: an ergonomic shape for gripping, a first handle end, and a second handle end, wherein the first handle end is connected to the second body end of the elongate body, and wherein the second handle end comprises a receiving port;
a disposable razor blade assembly comprising: a head fixedly assembled with a razor, a first assembly end configured to connectably engage with the receiving port, and a second assembly end; and
a razor blade assembly rack configured to hold the disposable razor blade assembly and at least one other disposable razor blade assembly in a substantially parallel fashion, wherein when the disposable razor blade assembly is held in the razor blade assembly rack, the first assembly end is accessible to engage with the receiving port of the second handle end of the elongate handle to facilitate extraction of the disposable razor blade assembly from the razor blade assembly rack.

21. The sanitary straight razor system of claim 20, wherein the head comprises a first head size and the blade fixedly assembled with the head comprises a first blade size, wherein the at least one other disposable razor blade assembly comprises a head fixedly assembled with a blade, and wherein:
the head of the at least one other disposable razor blade assembly comprises a second head size different from the first head size; or
the blade fixedly assembled with the head of the at least one other disposable razor blade assembly comprises a second blade size different from the first blade size.
